(19) United States
(12) Patent Application Publication
(10) Pub. No.: US 2026/0277498 A1
(43) Pub. Date: Sep. 17, 2026

(54) INFORMATION PROCESSING APPARATUS, CONTROL METHOD OF INFORMATION PROCESSING APPARATUS, ELECTRONIC DEVICE, CONTROL METHOD OF ELECTRONIC DEVICE, INFORMATION PROCESSING SYSTEM, CONTROL METHOD OF INFORMATION PROCESSING SYSTEM, PROGRAM, AND STORAGE MEDIUM

(71) Applicant: Canon Kabushiki Kaisha, Tokyo (JP)

(72) Inventor: RURIKO MIKAMI, Kanagawa (JP)

(21) Appl. No.: 19/564,278

(22) Filed: Mar. 12, 2026

(30) Foreign Application Priority Data
Mar. 17, 2025 (JP) 2025-042399

(51) Int. Cl. G06F 3/12

(52) U.S. Cl. CPC G06F 3/1205; G06F 3/1258

(57) ABSTRACT

An information-processing-apparatus which is capable of communicating with an electronic device and is characterized by including: an acceptance-unit configured to accept a setting change operation for a specific-setting-item of electronic-device; a transmission-unit configured to transmit, to electronic-device, a content of a setting change accepted by acceptance-unit, in order to reflect content of setting change in electronic-device; a first-acquisition-unit configured to acquire, from electronic-device, first information for displaying a setting-change-screen that is displayable after predetermined user authentication is performed in a case where electronic-device is in a second-operation-mode, among a first-operation-mode in which setting change of specific-setting-item related to electronic-device is allowed without performing predetermined user authentication and second-operation-mode in which setting change of specific-setting-item is not allowed unless predetermined user authentication is performed; and a display control-unit configured to perform control to display a screen based on first information acquired by first-acquisition-unit.

This application claims the benefit of Japanese Patent Application No. 2025-042399, filed March 17, 2025, which is hereby incorporated by reference wherein in its entirety.

### BACKGROUND

### Field of the Technology

The present disclosure relates to an information processing apparatus, a control method of an information processing apparatus, an electronic device, a control method of an electronic device, an information processing system, a control method of an information processing system, a program, and a storage medium.

### Description of the Related Art

There is a known system in which, for providing a service to an electronic device, a permission acceptance screen is displayed, and the service is provided to the electronic device in a case where consent of a user is obtained. Japanese Patent Laid-Open No. 2020-019238 discloses a system in which consent is obtained from a user of an electronic device regarding permission for information transmission, and status information is transmitted to a server and utilized for a service.

Regarding consent of a user, there may be a case in which only an administrator who is granted authority to manage an electronic device is able to change settings. For example, there is a case in which an electronic device is shared and utilized by multiple people for company operations. As a restriction method in which only an administrator is allowed to change settings, there is a method utilizing authentication based on a password notified only to the administrator. In this case, change of settings is allowed only in a case where authentication of an administrator is successful. Such a state as described above in which there is a restriction such that only a user who has successfully authenticated is able to change settings is referred to as, for convenience, an administrator mode.

In the administrator mode, in a case where an information processing apparatus attempts to change settings of the electronic device via an unauthenticated route, an error indicating that the change of settings is not allowed is returned from the electronic device to the information processing apparatus. Further, Japanese Patent Laid-Open No. 2023-109429 discloses a technology for presenting information for a user on a display of an information processing apparatus by switching to a screen of an electronic device.

In general, in a case where an electronic device is in the administrator mode and an information processing apparatus is unable to change settings of the electronic device, it is possible to display an error on the display of the information processing apparatus. However, it is not possible to change settings of the electronic device by guiding a user to a method for changing settings of the electronic device.

### SUMMARY

In view of the above-described problem, the present disclosure aims to provide a mechanism capable of improving operability in reflecting a content of a setting change that is accepted by an information processing apparatus regarding a specific setting item for the electronic device and transmitted to the electronic device.

An information processing apparatus according to an embodiment of the present disclosure is an information processing apparatus which is capable of communicating with an electronic device and is characterized by including: an acceptance unit configured to accept a setting change operation for a specific setting item of the electronic device; a transmission unit configured to transmit, to the electronic device, a content of a setting change accepted by the acceptance unit, in order to reflect the content of the setting change in the electronic device; a first acquisition unit configured to acquire, from the electronic device, first information for displaying a setting change screen that is displayable after predetermined user authentication is performed in a case where the electronic device is in a second operation mode, among a first operation mode in which the setting change of the specific setting item related to the electronic device is allowed without performing the predetermined user authentication and the second operation mode in which the setting change of the specific setting item is not allowed unless the predetermined user authentication is performed; and a display control unit configured to perform control to display a screen based on the first information acquired by the first acquisition unit.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a system;

FIG. 2A and FIG. 2B are block diagrams of an image processing apparatus and a mobile terminal;

FIG. 3 is a diagram illustrating a consent status of the image processing apparatus;

FIG. 4 is a screen flow diagram illustrating consent acceptance processing for permission in the mobile terminal;

FIG. 5 is a screen flow diagram illustrating consent acceptance processing for permission in the image processing apparatus;

FIG. 6 is a flowchart illustrating a method for controlling an application of the mobile terminal;

FIG. 7 is a flowchart illustrating a method for controlling an application of the mobile terminal and an application of the image processing apparatus; and

FIG. 8 is a flowchart illustrating a method for controlling an application of the mobile terminal.

### DESCRIPTION OF THE EMBODIMENTS

### First Embodiment

First, a description is given of an outline of the first embodiment. As described above, the administrator mode is one of the states of an electronic device such as an image processing apparatus, and indicates a state in which there is a restriction such that only a user who has successfully authenticated is able to change settings. That is, unless authentication is successful, a setting change of a specific setting item cannot be performed. For example, in a case where the administrator mode is set to "enabled"(also referred to as a second operation mode), authentication is required in a case where a specific setting item is to be changed. On the other hand, in a state where the administrator mode is "disabled" (also referred to as a first operation mode), a setting change of a specific setting item related to the image processing apparatus can be performed without predetermined user authentication. Note that whether the administrator mode is "enabled" or "disabled" can be set in a case where, for example, login to the image processing apparatus is performed using an account having administrator authority.

In the image processing apparatus, the setting of the administrator mode can be switched to "enabled" or "disabled". Further, in a case where the administrator mode is set to "enabled" in setting items of the image processing apparatus, a consent status for permission required to provide a service to the image processing apparatus can be set after user authentication in the image processing apparatus is successfully performed. Further, in the setting of this consent status, in a case where the consent status is set to "CONSENTED", the image processing apparatus is able to receive the service to be provided.

On the other hand, in a case where the administrator mode, which allows change of settings based on successful authentication, is set to "enabled" and an attempt is made to change settings of the image processing apparatus via an unauthenticated route, an error indicating that the setting of the consent status for permission cannot be changed is returned from the image processing apparatus. Specifically, for example, in a case of utilizing a specific function in an application that is related to an image processing apparatus and is installed in an information processing apparatus such as a mobile terminal, consent to permission is necessary. In such a case, setting of the consent status is normally performed within the application. However, in a case where the administrator mode is set to "enabled" in the image processing apparatus, setting of the consent status from within the application, which is an unauthenticated route, is not allowed. Therefore, the image processing apparatus returns an error to the mobile terminal.

In the following embodiments, a description is given of a method for resolving an issue that a consent status for permission cannot be set in an application of a mobile terminal due to such settings of an image processing apparatus as described above. Note that, in the following description, as an example, an information processing apparatus is described as a mobile terminal, and an electronic device is described as an image processing apparatus.

Hereinafter, a description is given about forms for carrying out the present disclosure with reference to the drawings. Note that the relative arrangement of each constituent element of the apparatuses used in these embodiments, the shapes of the apparatuses, etc., are merely examples, and are not limited thereto. Furthermore, in the accompanying drawings, the same or similar configurations are denoted by the same reference numerals, so that duplicated descriptions are omitted.

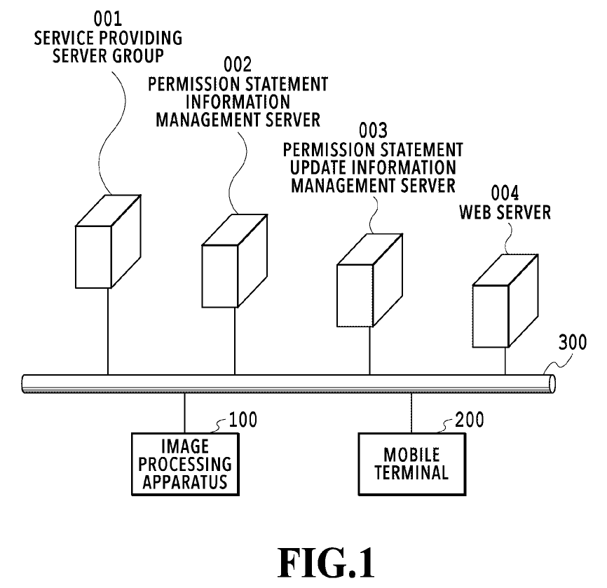

FIG. 1 is a configuration diagram illustrating the overall configuration of a system according to the present embodiment. The information processing system of the present embodiment includes the service providing server group 001, the permission statement information management server 002, the permission statement update information management server 003, the web server 004, the application providing server 005, the image processing apparatus 100, and the mobile terminal 200, which are communicably connected to each other through the communication network 300.

The service providing server group 001 is a server for providing a service of the image processing apparatus 100 in cooperation with a cloud server system (a server system on the Internet). In the cloud server system, there are services such as printing image data stored on the cloud (on the Internet) using the image processing apparatus 100 and storing image data scanned by the image processing apparatus 100 on the cloud.

The permission statement information management server 002 manages the latest permission version of a permission statement. In a case where a change occurs in a permission statement to which a user is to give consent, due to addition of a function, a legal amendment, etc., the latest permission version is updated.

The permission statement update information management server 003 manages a transmittable permission version on a per country basis, as a permission version required for performing transmission of information. Further, the permission statement update information management server 003 determines the country in which the image processing apparatus 100 is installed, and returns the transmittable permission version of permission corresponding to that country. In a case where a change occurs in a permission statement for which consent of a user is required, due to addition of a function, a legal amendment, etc., transmittable permission version information in the server is updated.

The web server 004 stores the latest permission statements for each region. The application providing server 005 is a server for providing application software (hereinafter referred to as applications) to be installed and utilized in the image processing apparatus 100. Applications are for providing a service in cooperation with the service providing server group 001. For example, there is an application that transmits image data scanned by the image processing apparatus 100 to the service providing server group 001 that cooperates with a cloud server system.

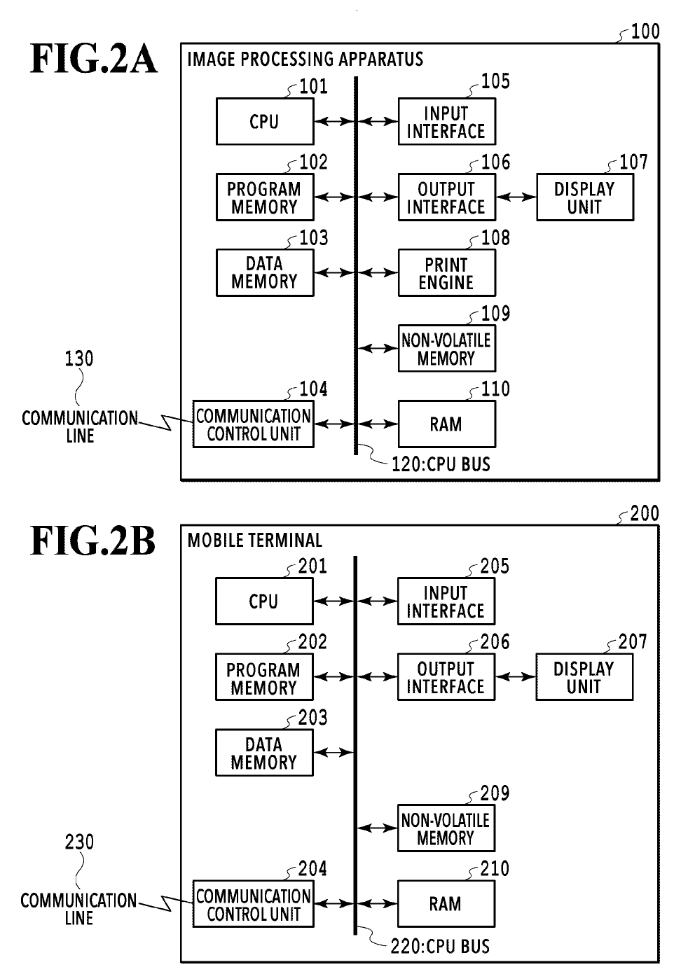

FIG. 2A and FIG. 2B are block diagrams of an image processing apparatus and a mobile terminal. FIG. 2A is a diagram illustrating the configuration of the image processing apparatus 100 in the present embodiment. The image processing apparatus 100 is an electronic device. The image processing apparatus 100 includes the CPU 101, the program memory 102, the data memory 103, the communication control unit 104, the input interface 105, the output interface 106, the display unit 107, the print engine 108, the non-volatile memory 109, and the RAM 110.

The CPU 101 is a system control unit, and controls the entire image processing apparatus 100. The program memory 102 stores a control program to be executed by the CPU 101, an embedded operating system program, and the like. The data memory 103 stores program control variables and the like, and is equipped with various work buffer areas utilized during processing by the print engine 108.

The communication control unit 104 controls transmission and reception of data with the outside via the communication line 130. The input interface 105 is an interface for receiving data input and operation instructions from a user, and is composed of a physical keyboard, buttons, a touch panel, and the like. Note that, as another possible form, the later-described output interface 106 and input interface 105 may be configured as the same configuration, so that both screen output and reception of an operation from a user are performed by the same configuration. The output interface 106 is an interface that performs control for causing the display unit 107 to display data and provide a notification of a state of the image processing apparatus 100.

The display unit 107 is composed of an LED (light-emitting diode), an LCD (liquid crystal display), or the like, and displays data and provides a notification of a state of the image processing apparatus 100. Note that it is also possible to accept an input from a user via the display unit 107 by installing a soft keyboard including keys such as numeric input keys, a mode setting key, an enter key, a cancel key, a power supply key, etc., on the display unit 107. Further, display control of screens to be displayed on the display unit 107 is performed by the CPU 101. The print engine 108 forms an image on a print medium such as paper using a printing material such as ink, based on information stored in the data memory 103 and a received print job, thereby outputting a print result.

The non-volatile memory 109 is composed of devices such as an EEPROM (Electrically Erasable Programmable Read-Only Memory) and a flash memory. The non-volatile memory 109 is mainly used for storing data such as setting values of the image processing apparatus 100, which need to be retained even while power is not supplied to the image processing apparatus 100. Hereinafter, the non-volatile memory 109 is also referred to as a storage unit. The RAM 110 is composed of a DRAM (Dynamic Random Access Memory) or the like that requires a backup power supply. The RAM 110 is also used as a main memory and a work memory of the CPU 101, and functions as a reception buffer for temporarily storing print information received from a PC or the like and stores various kinds of information. The above-described constituent elements 101 to 106 and 108 to 110 are mutually connected via the CPU bus 120, which is managed by the CPU 101.

The image processing apparatus 100 is capable of communicating with each server indicated by 001 to 005 and the mobile terminal 200 via the communication network 300. The image processing apparatus 100 communicates with each server indicated by 001 to 005, acquires a permission statement as well as a permission version associated with the permission statement, and retains the acquired permission statement and permission version in the non-volatile memory 109.

FIG. 2B is a diagram illustrating the configuration of the mobile terminal 200, which is an example of an electronic device in the present embodiment. The mobile terminal 200 includes the CPU 201, the program memory 202, the data memory 203, the communication control unit 204, the input interface 205, the output interface 206, the display unit 207, the non-volatile memory 209, and the RAM 210.

The CPU 201 is a system control unit, and controls the entire mobile terminal 200. The program memory 202 stores a control program to be executed by the CPU 201, an embedded operating system program, and the like. The data memory 203 stores program control variables and the like, and is equipped with various work buffer areas.

The communication control unit 204 controls transmission and reception of data with the outside via the communication line 230. The input interface 205 is an interface for receiving data input and operation instructions from a user, and is composed of a physical keyboard, buttons, a touch panel, and the like. Note that, as another possible form, the later-described output interface 206 and input interface 205 may be configured as the same configuration, so that both screen output and reception of an operation from a user are performed by the same configuration. The output interface 206 is an interface that performs control for causing the display unit 207 to display data and provide a notification of a state of the mobile terminal 200.

The display unit 207 is composed of an LED (light-emitting diode), an LCD (liquid crystal display), or the like, and displays data and provides a notification of a state of the mobile terminal 200. Note that it is also possible to accept an input from a user via the display unit 207 by installing a soft keyboard including keys such as numeric input keys, a mode setting key, an enter key, a cancel key, a power supply key, etc., on the display unit 207. Further, display control of screens to be displayed on the display unit 207 is performed by the CPU 201. The non-volatile memory 209 is composed of devices such as an EEPROM (Electrically Erasable Programmable Read-Only Memory) and a flash memory. The non-volatile memory 209 is mainly used for storing data such as setting values of the mobile terminal 200, which need to be retained even while power is not supplied to the mobile terminal 200.

The RAM 210 is composed of a DRAM (Dynamic Random Access Memory) or the like that requires a backup power supply. The RAM 210 is also used as a main memory and a work memory of the CPU 201, and functions as a transmission buffer for temporarily storing information to be transmitted to the mobile terminal 200 and stores various kinds of information. The above-described constituent elements 201 to 206 and 209 to 210 are mutually connected via the CPU bus 220, which is managed by the CPU 201.

The mobile terminal 200 is capable of communicating with each server indicated by 001 to 004 and the image processing apparatus 100 via the communication network 300. The mobile terminal 200 communicates with each server indicated by 001 to 004, acquires a permission statement as well as a permission version associated with the permission statement, and retains the acquired permission statement and permission version in the non-volatile memory 209.

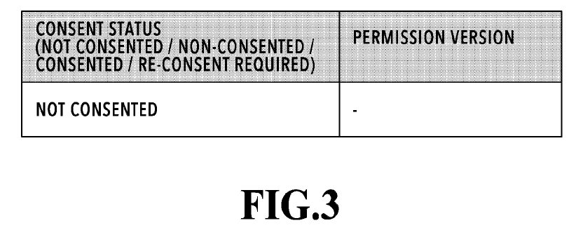

FIG. 3 is a diagram illustrating a consent status of the image processing apparatus 100 in the present embodiment. In the present embodiment, a consent status refers to a status of user’s consent for transmitting information from the image processing apparatus 100 (an electronic device) to a transmission destination such as the service providing server group 001. The consent status includes four states: "NOT CONSENTED (NOT PERMITTED)," "NON-CONSENTED (NON-PERMITTED)," "CONSENTED (PERMITTED)," and "RE-CONSENT REQUIRED (RE-PERMISSION REQUIRED)." "NOT CONSENTED" refers to a state in which neither consent nor non-consent has been given to a permission statement. "NOT CONSENTED" is the initial value, which is set at the time the image processing apparatus 100 is shipped from a factory. "RE-CONSENT REQUIRED" refers to a state in which a change has occurred in a permission statement to which a user is to give consent, due to a legal amendment or the like, and it is necessary to confirm the user’s intention to consent again. The CPU 101 of the image processing apparatus 100 periodically communicates with the permission statement update information management server 003 and acquires a transmittable permission version for each permission type. Further, in a case where the transmittable permission version is greater than the permission version in FIG. 3, the consent status is set to "RE-CONSENT REQUIRED".

"CONSENTED" refers to a state in which a user has given consent to a permission statement managed by the permission statement information management server 002, and the permission version of the permission statement at the time of giving the consent is recorded. "NON-CONSENTED" refers to a state in which a user has given non-consent to a permission statement managed by the permission statement information management server 002. The consent status illustrated in FIG. 3 is retained in the non-volatile memory 109.

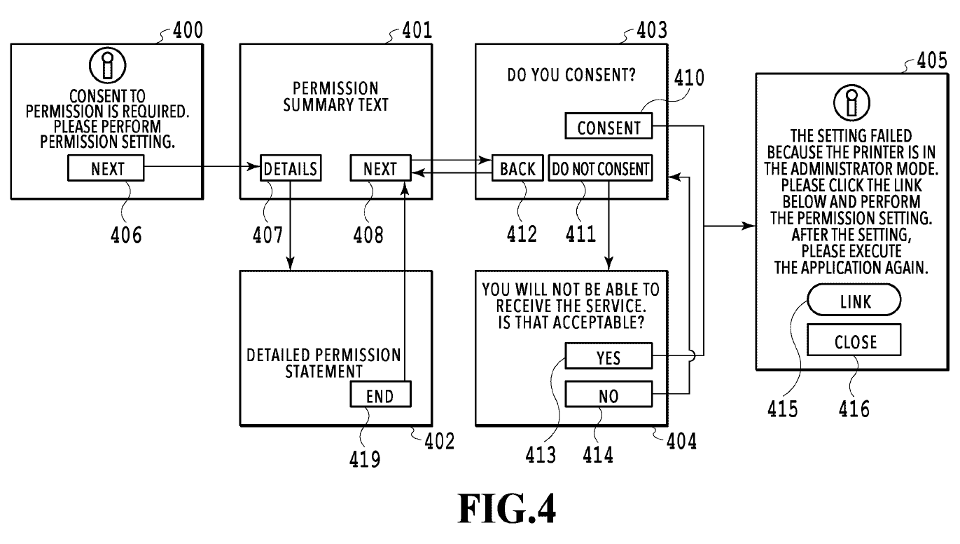

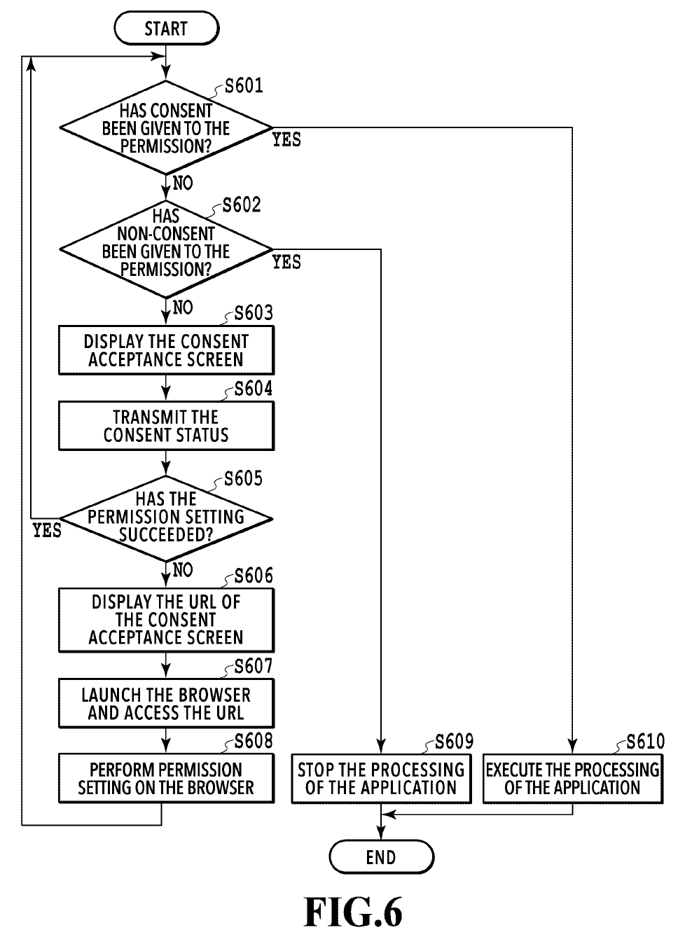

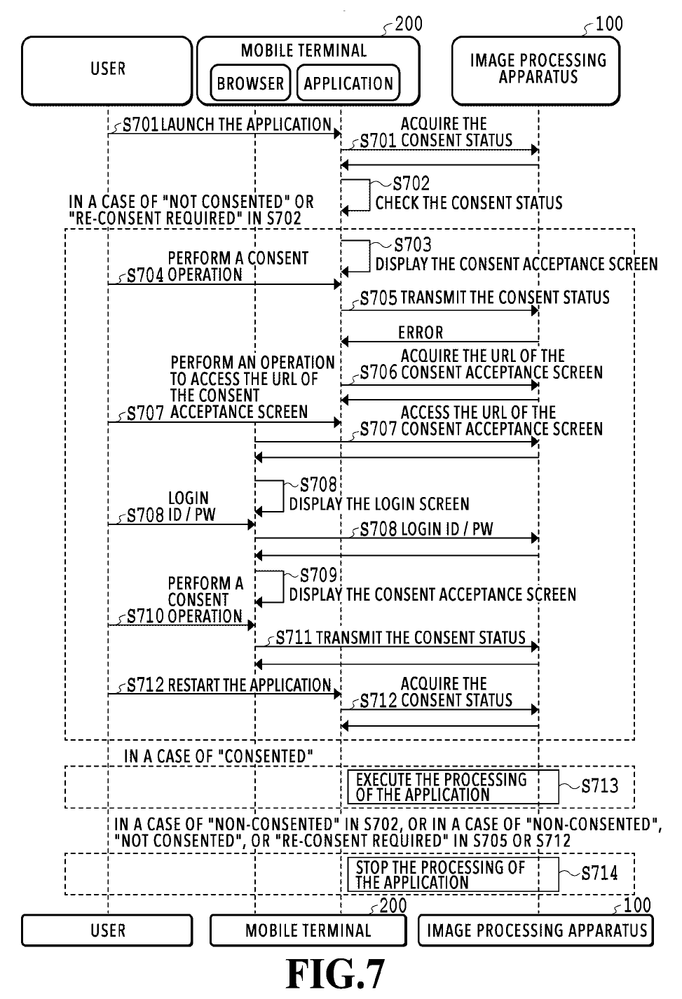

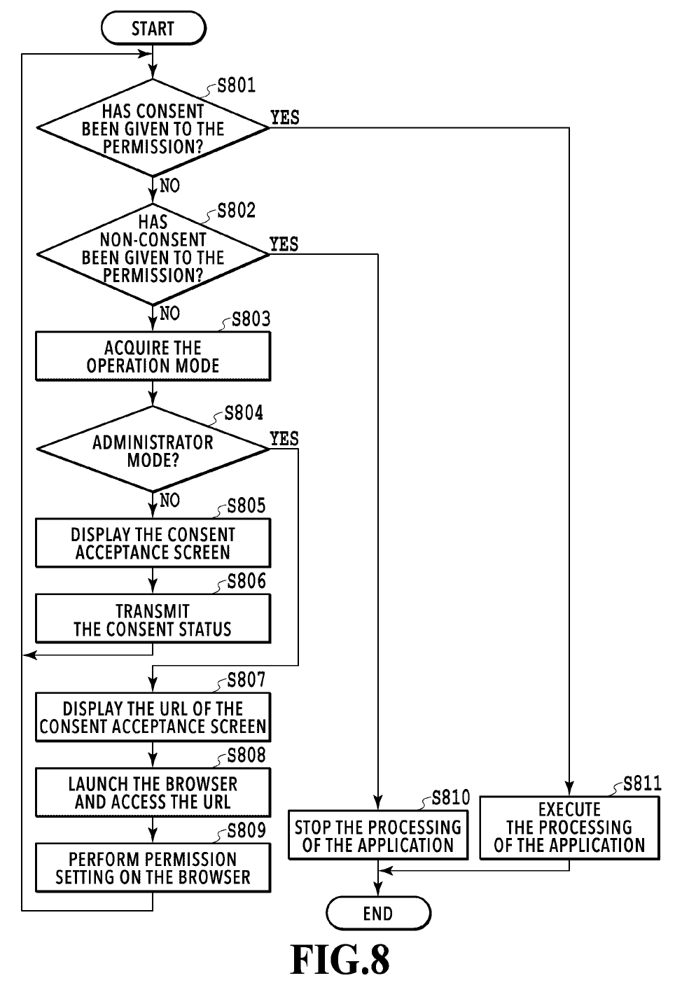

FIG. 4 is a screen flow diagram illustrating consent acceptance processing for permission in the mobile terminal 200 in the present embodiment. Note that the present screen flow is the processing performed in a case where the administrator mode is "enabled" in the image processing apparatus 100. Each process in the present screen flow is implemented by the CPU 201 loading an application program stored in the program memory 202 into the RAM 210 and executing it. The present screen flow is executed in S603 in FIG. 6, S703 to S705 in FIG. 7, and S805 in FIG. 8, which are described later.

First, the display screen 400 is an information screen that notifies a user that permission is required. The CPU 201 reads out the information screen from the RAM 210, and displays the display screen 400 on the display unit 207. In a case where pressing of the "NEXT" button 406 is detected via the input interface 205, the CPU 201 displays the screen 401. The screen 401 is a screen that displays a permission summary text. That is, the CPU 201 reads out, from the non-volatile memory 209, the summary text of permission for which consent acceptance processing is currently being performed, and displays the screen 401. In a case where pressing of the "DETAILS" button 407 is detected via the input interface 205, the CPU 201 displays the screen 402. In a case where pressing of the "NEXT" button 408 is detected, the CPU 201 displays the screen 403.

The screen 402 is a screen that displays details of a permission statement. The CPU 201 acquires a detailed permission statement from the web server 004 via the communication control unit 204, and displays the screen 402. In a case where pressing of the "END" button 409 is detected via the input interface 205, the CPU 201 displays the screen 401 again. The screen 403 is a screen for accepting consent. A user can perform an operation of changing the setting of a consent status on the screen 403. The CPU 201 reads out the text "DO YOU CONSENT?" from the non-volatile memory 209, and displays the text on the display unit 207. In a case where pressing of the "CONSENT" button 410 is detected via the input interface 205, the CPU 201 acquires a permission version from the permission statement information management server 002 via the communication control unit 204. Then, the permission version as well as information indicating "CONSENT" to the permission are transmitted to the image processing apparatus 100 via the communication control unit 204. Note that the information transmitted at this time is encrypted and transmitted to the image processing apparatus 100. In a case where a response indicating that a setting change of the consent status has been accepted is received from the image processing apparatus 100, the CPU 201 ends the present screen flow. On the other hand, in a case where a response indicating that a setting change of the consent status cannot be accepted is received, the CPU 201 displays the screen 405. Further, in a case where pressing of the "DO NOT CONSENT" button 411 is detected via the input interface 205, the CPU 201 displays the screen 404.

The screen 404 is a screen for accepting non-consent. The CPU 201 reads out, from the non-volatile memory 209, a text indicating that a service cannot be received due to non-consent, and displays the text on the display unit 207. In a case where pressing of the "YES" button 413 is detected via the input interface 205, the CPU 201 transmits the consent status of "DO NOT CONSENT" to the image processing apparatus 100 via the communication control unit 204. In a case where a response indicating that a setting change of the consent status has been accepted is received from the image processing apparatus 100, the CPU 201 ends the present screen flow. On the other hand, in a case where a response indicating that a setting change of the consent status cannot be accepted is received, the CPU 201 displays the screen 405. Note that a case where a response indicating that a setting change of the consent status cannot be accepted is received is a case where the administrator mode is set to "enabled" in the image processing apparatus 100. On the other hand, a case where a response indicating that a setting change of the consent status has been accepted is received from the image processing apparatus 100 is a case where the administrator mode is set to "disabled", and in this case, the consent setting is allowed without user authentication required. That is, in a case where "CONSENT" is selected on the screen 403, or in a case where the "YES" button 413 is selected on the display screen 404, whether the display screen 405 is displayed is further determined based on whether or not the image processing apparatus 100 is in the administrator mode.

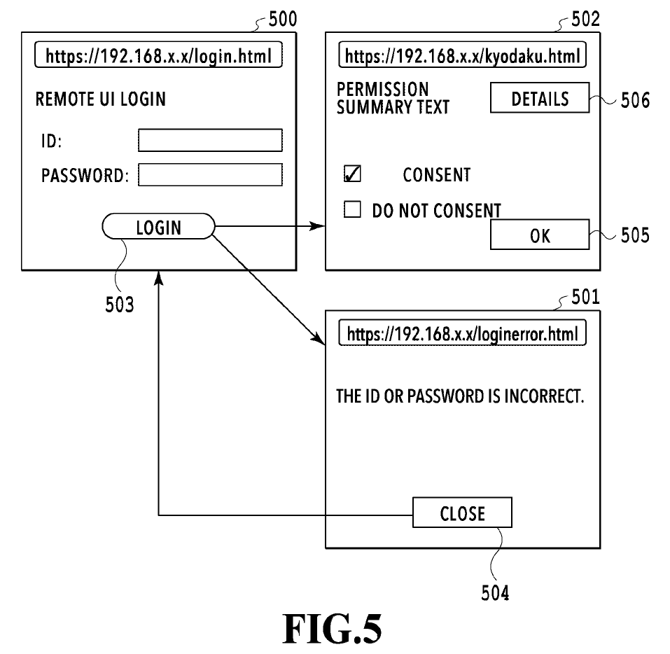

The screen 405 is a screen for guiding a user to a consent acceptance screen in an embedded web browser included in the image processing apparatus 100. The "LINK" button 415 is associated with a URL (information for accessing a web server in the electronic device) of an embedded web browser included in the image processing apparatus 100. By accessing the URL, such consent acceptance screens provided by the image processing apparatus 100 as illustrated in FIG. 5 can be opened. In a case where pressing of the "LINK" button 415 is detected via the input interface 205, the CPU 201 launches the browser and accesses the URL associated with the "LINK" button 415. In a case where pressing of the "CLOSE" button 416 is detected via the input interface 205, the CPU 201 closes the present display screen and displays the top screen of the application.

FIG. 5 is a screen flow diagram illustrating consent acceptance processing for permission in the image processing apparatus 100 in the present embodiment. The consent acceptance screens illustrated in FIG. 5 are screens that can be displayed by the image processing apparatus 100 by accessing an embedded web browser included in the image processing apparatus 100. Therefore, each process in the present screen flow diagram is implemented by the CPU 101 loading the program of an embedded web browser stored in the program memory 102 into the RAM 110 and executing it. Note that the present screens are the screens displayed in S606 in FIG. 6, S707 to S711 in FIG. 7, and S808 in FIG. 8, which are described later.

First, the screen 500 is a screen for performing authentication. Upon detecting access to the URL of the consent acceptance screen via the communication control unit 104, the CPU 101 displays the screen 500. In a case where pressing of the "LOGIN" button 503 is received via the communication control unit 104, the CPU 101 reads out an administrator ID and a password stored in the non-volatile memory 109 and compares and verifies the administrator ID and the password with values input to the ID field and the password field of the screen 500. If the values match, the screen 502 is displayed, and if not, the screen 501 is displayed.

The screen 501 is a screen indicating a login error. The CPU 101 displays an indication that the ID or the password is incorrect. In a case where pressing of the "CLOSE" button 504 is received, the screen 500 is displayed. The screen 502 is a screen indicating a permission summary text. In a case where pressing of the "OK" button 505 is received, on a condition that the check box indicates "CONSENT", the CPU 101 sets "CONSENTED" as the consent status illustrated in FIG. 3. That is, the CPU 101 acquires a permission version from the permission statement information management server 002 via the communication control unit 104, and sets the acquired value to the permission version illustrated in FIG. 3. On the other hand, in a case where the check box indicates "DO NOT CONSENT", "NON-CONSENTED" is set as the consent status. Then, the CPU 101 responds with a message screen for guiding a user to operate the application or the top screen of the embedded web browser, and terminates the present screen flow.

FIG. 6 is a flowchart illustrating a method for controlling an application of the mobile terminal 200 in the present embodiment. Each process in the present flowchart is implemented by the CPU 201 of the mobile terminal 200 loading a program stored in the program memory 202 into the RAM 210 and executing it. The present flowchart starts on a condition that the CPU 201 launches an application. Note that "S" in the following description of each process indicates a step in the flowchart.

In S601, the CPU 201 determines whether consent has been given to permission by acquiring the consent status from the image processing apparatus 100 via the communication control unit 204. In a case where it is determined that consent has been given to the permission, the CPU 201 proceeds to S610, and in a case where it is determined that consent has not been given to the permission, the CPU 201 proceeds to S602. In S602, the CPU 201 determines whether non-consent has been given to the permission. In a case where it is determined that non-consent has been given to the permission, the CPU 201 proceeds to S609, and in a case where it is determined that non-consent has not been given to the permission (that is, NOT CONSENTED or RE-CONSENT REQUIRED), the CPU 201 proceeds to S603.

In S603, the CPU 201 displays such a screen for the consent acceptance processing as illustrated in FIG. 4. That is, the CPU 201 executes the screen flow processing described in FIG. 4 and accepts the setting change of the consent status in accordance with a setting change operation by a user. In S604, the CPU 201 transmits, to the image processing apparatus 100 via the communication control unit 204, the content of the accepted setting change of the consent status. In S605, the CPU 201 determines whether the setting of the permission has succeeded. In a case where a response indicating that the setting change of the consent status has been accepted is received from the image processing apparatus 100, it is determined that the setting of the permission has succeeded, and the CPU 201 proceeds to S601. On the other hand, in a case where a response indicating that the setting change of the consent status cannot be accepted is received, it is determined that the setting of the permission has not succeeded, and the CPU 201 proceeds to S606. Note that, in the present processing, the case where a response indicating that the setting change of the consent status cannot be accepted is received is assumed to be based on the administrator mode being set to "enabled" in the image processing apparatus 100. However, other than the above, there may be possible cases in which the setting of permission fails. For example, there may be a case in which the mobile terminal 200 cannot receive a response from the image processing apparatus 100 for a reason such as the power supply of the image processing apparatus 100 being turned off. In such a case, an error screen may be displayed on the display screen of the mobile terminal 200, and the processing may proceed to the process of terminating the processing of the application (S609).

In S606, the CPU 201 acquires the URL of a consent acceptance screen from the image processing apparatus 100 via the communication control unit 204, and displays a screen for guiding a user to such a consent acceptance screen provided by the image processing apparatus 100 as the screen 405 in FIG. 4. In a case where pressing of the "LINK" button 415 is detected on the screen 405, the CPU 201 proceeds to S607. Note that, in a case where pressing of the "CLOSE" button 416 is detected on the screen 405, the CPU 201 may control the processing to proceed to S609.

In S607, the CPU 201 launches a browser included in the mobile terminal 200 and accesses the URL of an embedded web browser included in the image processing apparatus 100. Such a screen indicating the consent acceptance processing as illustrated in FIG. 5 is displayed on the embedded web browser included in the image processing apparatus 100. In S608, in the embedded web browser included in the image processing apparatus 100, the CPU 201 accepts the setting change of the consent status in accordance with a setting change operation by a user. That is, the screen flow processing described with reference to FIG. 5 is executed. After setting the consent status, the CPU 201 returns to S601.

In S609, the CPU 201 stops the processing of the application. After that, the CPU 201 terminates the processing of the present flowchart. In S610, the CPU 201 executes the processing of the application. After that, the CPU 201 terminates the processing of the present flowchart.

FIG. 7 is a flowchart illustrating a method for controlling an application of the mobile terminal 200 and the image processing apparatus 100 in the present embodiment. Each process performed by the mobile terminal in the present flowchart is implemented by the CPU 201 of the mobile terminal 200 loading a program stored in the program memory 202 into the RAM 210 and executing it. Further, each process performed by the image processing apparatus 100 in the present flowchart is implemented by the CPU 101 of the image processing apparatus 100 loading a program stored in the program memory 102 into the RAM 110 and executing it. The present flowchart starts on a condition that the CPU 201 of the mobile terminal 200 launches an application.

In S701, upon detecting the launch of an application, the CPU 201 of the mobile terminal 200 acquires, via the communication control unit 204, the consent status stored in the image processing apparatus 100. At this time, the CPU 101 of the image processing apparatus 100 reads out the consent status stored in the non-volatile memory 109 and replies with the consent status.

In S702, the CPU 201 performs branching of the processing based on the acquired consent status. That is, in a case where the received consent status is "NOT CONSENTED" or "RE-CONSENT REQUIRED", the CPU 201 proceeds to S703. Further, in a case where the consent status is "CONSENTED", the CPU 201 proceeds to S713. Further, in a case where the consent status is "NON-CONSENTED", the CPU 201 proceeds to S714.

In S703, the CPU 201 displays such a consent acceptance processing screen as illustrated in FIG. 4 on the display unit 207. In S704, the user refers to the consent acceptance processing screen on the display unit 207 and performs an operation of changing the setting to "CONSENTED" or "NON-CONSENTED" via the input interface 205.

In S705, the CPU 201 transmits, to the image processing apparatus 100 via the communication control unit 204, the consent status of "CONSENTED" or "NON-CONSENTED," which is set in S704. At this time, the CPU 101 of the image processing apparatus 100 reads out the setting of the administrator mode, which is stored in the non-volatile memory 109, and, in a case where the administrator mode is "disabled", the CPU 101 replies that the setting change of the consent status has been accepted. At this time, in a case where it is detected that "CONSENTED" has been accepted, the CPU 201 proceeds to S713, and, in a case where it is detected that "NON-CONSENTED" has been accepted, the CPU 201 proceeds to S714.

On the other hand, in a case where the administrator mode is "enabled", the image processing apparatus 100 replies that the setting change of the consent status cannot be accepted (error). In a case where the reply indicating an error is received, the CPU 201 proceeds to S706. Note that, in a case where the processing is terminated in S704 for some reason while neither "CONSENTED" nor "NON-CONSENTED" is selected, "NOT CONSENTED" or "RE-CONSENT REQUIRED" remains stored as the consent status in the non-volatile memory 109 of the image processing apparatus 100. In this case, the CPU 201 proceeds to step S714.

In S706, the CPU 201 acquires, via the communication control unit 204, the URL of the consent acceptance screen (FIG. 5) of an embedded web browser included in the image processing apparatus 100. For example, a URL such as https://192.168.xx.xx/kyodaku.html is acquired. Further, the screen 405 for guiding a user to the consent acceptance processing on the embedded web browser of the image processing apparatus 100 is displayed on the display unit 207. Then, the processing waits for an operation from the user.

In S707, the user requests access to the URL via the input interface 205. Upon detecting the request, the CPU 201 of the mobile terminal 200 launches the web browser and accesses the URL via the communication control unit 204. At this time, the CPU 101 of the image processing apparatus 100 returns a login screen (the screen 500).

In S708, the CPU 201 displays the login screen (the screen 500) on the display unit 207 displaying the web browser. The user inputs a login ID and password and requests login via the input interface 205. Upon detecting the login request, the CPU 201 transmits the ID and password to the image processing apparatus 100 via the communication control unit 204. At this time, the CPU 101 of the image processing apparatus 100 reads out an administrator ID and a password stored in the non-volatile memory 109, and compares and verifies the administrator ID and the password with the values of the received ID and password. If they match, the consent acceptance processing screen (the screen 502) is returned. If not, the login error screen (the screen 501) is returned.

In S709, the CPU 201 displays the consent reception processing screen (the screen 502) on the display unit 207 displaying the web browser. Then, the processing waits for an operation from the user. In S710, the user refers to the display unit 207 displaying the web browser and performs an operation of changing the setting for the permission via the input interface 205. In S711, the CPU 201 transmits, via the communication control unit 204, the consent status (CONSENTED or NON-CONSENTED) on the consent acceptance processing screen (the screen 502). At this time, the CPU 101 of the image processing apparatus 100 stores "CONSENTED" or "NON-CONSENTED" as the consent status illustrated in FIG. 3. Note that, in a case where the processing is terminated for some reason while neither "CONSENTED" nor "NON-CONSENTED" is selected on the screen 502, "NOT CONSENTED" or "RE-CONSENT REQUIRED" remains stored as the consent status illustrated in FIG. 3. Thereafter, the CPU 101 replies with a message screen that guides a user to operate the application, or replies with the top screen of the embedded web browser.

In S712, the user performs an operation to restart the application. Upon detecting the launch of the application, the CPU 201 of the mobile terminal 200 acquires the consent status via the communication control unit 204. At this time, the CPU 101 of the image processing apparatus 100 returns the value of the consent status illustrated in FIG. 3. In a case where the consent status is "CONSENTED", the processing proceeds to S713. In a case where the consent status is "NON-CONSENTED", "NOT CONSENTED", or "RE-CONSENT REQUIRED", the processing proceeds to S714.

In S713, the CPU 201 executes processing of the application that is currently being controlled. For example, processing such as cooperating with the image processing apparatus 100 and storing image data scanned by the image processing apparatus 100 on the cloud is performed. In S714, the CPU 201 stops the processing of the application that is currently being controlled, and terminates the processing of the present flowchart.

As described above, according to the present embodiment, it is possible to provide a mechanism capable of improving operability in reflecting a content of a setting change that is accepted by an information processing apparatus regarding a specific setting item for the electronic device and transmitted to the electronic device. Specifically, even in a case where the operation mode of the image processing apparatus 100 is the administrator mode, control of the consent acceptance processing can be performed on the mobile terminal 200 by guiding a user to an embedded web browser of the image processing apparatus 100. By the above-described control, the user can utilize an application.

### Second Embodiment

In the description of the first embodiment, in a case where the mobile terminal 200 receives an indication that a setting change of the consent status cannot be accepted, the mobile terminal 200 accesses a permission consent acceptance screen of an embedded web browser included in the image processing apparatus 100 to change the consent status. However, as a result, the consent acceptance processing in the application on the mobile terminal 200 ends up being unnecessary. Thus, in the second embodiment, the mobile terminal 200 acquires the operation mode of the image processing apparatus 100 before displaying the consent acceptance screen on the application. Further, in a case where the acquired operation mode is the administrator mode, the mobile terminal 200 accesses the permission consent acceptance screen of the embedded web browser included in the image processing apparatus 100 to change the consent status.

FIG. 8 is a flowchart illustrating a method for controlling an application of the mobile terminal 200 as well as a browser in the present embodiment. Each process in the present flowchart is implemented by the CPU 201 loading a program stored in the program memory 202 into the RAM 210 and executing it. The present flowchart starts on a condition that the CPU 201 launches an application.

In S801, the CPU 201 of the mobile terminal 200 determines whether consent has been given to permission by acquiring the consent status from the image processing apparatus 100 via the communication control unit 204. In a case where it is determined that consent has been given to the permission, the CPU 201 proceeds to S811. On the other hand, in a case where it is determined that consent has not been given to the permission, the processing proceeds to S802.

In S802, the CPU 201 of the mobile terminal 200 determines whether non-consent has been given to the permission, based on the consent status acquired from the image processing apparatus 100 via the communication control unit 204. In a case where it is determined that non-consent has been given to the permission, the CPU 201 proceeds to S810. In a case where it is determined that non-consent has not been given to the permission (that is, NOT CONSENTED or RE-CONSENT REQUIRED), the processing proceeds to S803.

In S803, the CPU 201 acquires the operation mode from the image processing apparatus 100 via the communication control unit 204. In S804, the CPU 201 determines whether the acquired operation mode is the "administrator mode." As described above, the administrator mode refers to a state in which the administrator mode setting in the image processing apparatus 100 is "enabled." In a case where it is determined that the operation mode is the administrator mode, the CPU 201 proceeds to S807. On the other hand, in a case where it is determined that the operation mode is not the administrator mode, the CPU 201 proceeds to S805.

In S805, the CPU 201 displays such a screen for the consent acceptance processing as illustrated in FIG. 4. That is, the CPU 201 executes the screen flow processing described in FIG. 4 and accepts the setting change of the consent status in accordance with a setting change operation by a user. In S806, the CPU 201 transmits, to the image processing apparatus 100 via the communication control unit 204, the content of the accepted setting change of the consent status.

In S807, the CPU 201 acquires the URL of a consent acceptance screen from the image processing apparatus 100 via the communication control unit 204, and displays a screen (the screen 405) for guiding a user to a consent acceptance screen provided by the image processing apparatus 100. In a case where pressing of the "LINK" button 415 is detected on the screen 405, the CPU 201 proceeds to S808. In S808, the CPU 201 launches a browser included in the mobile terminal 200 and accesses the URL of an embedded web browser included in the image processing apparatus 100. Such a screen indicating the consent acceptance processing as illustrated in FIG. 5 is displayed on the embedded web browser included in the image processing apparatus 100. In S809, on the embedded web browser included in the image processing apparatus 100, the CPU 201 accepts a setting change of the consent status in accordance with a setting change operation by a user. That is, the screen flow processing described with reference to FIG. 5 is executed. After setting the consent status, the CPU 201 returns to S801.

In S810, the CPU 201 stops the processing of the application, and terminates the processing of the present flowchart. In S811, the CPU 201 executes the processing of the application, and terminates the processing of the present flowchart.

As described above, according to the present embodiment, it is possible to appropriately display a setting change screen according to the operation mode of the image processing apparatus 100. Specifically, in a case where the administrator mode is "disabled," the consent acceptance processing is performed on an application of the mobile terminal 200. Further, in a case where the administrator mode is "enabled," it is possible to guide a user to the consent acceptance processing on an embedded web browser of the image processing apparatus 100 without performing the consent acceptance processing on the application of the mobile terminal 200. Accordingly, it is possible to avoid unnecessary processing, such as performing consent acceptance processing on an embedded web browser of the image processing apparatus 100 after performing consent acceptance processing on an application once, thereby improving operability.

Further, according to the present embodiment, in a case of reflecting a content of a setting change that is accepted by an information processing apparatus regarding a specific setting item for an electronic device and transmitted from the information processing apparatus to the electronic device, the content of a setting change can be suitably reflected even in a case where the electronic device is in the second operation mode. That is, it is possible to improve operability in reflecting a content of a setting change that is accepted by an information processing apparatus regarding a specific setting item for the electronic device and transmitted to the electronic device.

### Other Embodiments

Note that the various kinds of control described above as being performed by the image processing apparatus 100 may be performed by a single piece of hardware, or control of the entire apparatuses may be performed by multiple pieces of hardware (for example, multiple processors or circuits) by sharing the processing.

Further, although the present disclosure is described above in detail based on preferred embodiments thereof, the present disclosure is not limited to these specific embodiments, and various forms within a scope not departing from the gist of this disclosure are also included in the present invention. Furthermore, each of the embodiments described above merely indicates one embodiment of the present disclosure, and it is also possible to combine the embodiments as appropriate.

Further, in the above-described embodiments, a case where the present disclosure is applied to an image processing apparatus or a mobile terminal is described as an example; however, the present disclosure is not limited to this example and is applicable to a printer apparatus including a display or an information processing apparatus. Further, the present disclosure is also applicable to a personal computer, a PDA, a mobile phone terminal, a digital photo frame, a music player, a game machine, an electronic book reader, and the like.

As described above, according to the present disclosure, it is possible to improve operability in reflecting a content of a setting change that is accepted by an information processing apparatus regarding a specific setting item for the electronic device and transmitted to the electronic device.

Embodiment(s) of the present invention can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An information processing apparatus capable of communicating with an electronic device, the information processing apparatus comprising at least one memory and at least one processor and/or at least one circuit which function as:
an acceptance unit configured to accept a setting change operation for a specific setting item of the electronic device;
a transmission unit configured to transmit, to the electronic device, a content of a setting change accepted by the acceptance unit, in order to reflect the content of the setting change in the electronic device;
a first acquisition unit configured to acquire, from the electronic device, first information for displaying a setting change screen that is displayable after predetermined user authentication is performed in a case where the electronic device is in a second operation mode, among a first operation mode in which the setting change of the specific setting item related to the electronic device is allowed without performing the predetermined user authentication and the second operation mode in which the setting change of the specific setting item is not allowed unless the predetermined user authentication is performed; and
a display control unit configured to perform control to display a screen based on the first information acquired by the first acquisition unit.

2. The information processing apparatus according to claim 1,
wherein the first acquisition unit acquires the first information in a case where, in the electronic device, reflection of the content of the setting change transmitted by the transmission unit fails.

3. The information processing apparatus according to claim 1,
wherein the first acquisition unit does not acquire the first information in a case where, in the electronic device, reflection of the content of the setting change transmitted by the transmission unit succeeds.

4. The information processing apparatus according to claim 1,
wherein the specific setting item is a setting indicating a consent status of a user with respect to transmission of information from the electronic device to a transmission destination.

5. The information processing apparatus according to claim 1,
wherein the at least one memory and the at least one processor and/or at least one circuit further function as:
a second acquisition unit configured to acquire, from the electronic device, second information indicating whether or not the electronic device is in the second operation mode.

6. The information processing apparatus according to claim 5,
wherein, in a case where the second information acquired by the second acquisition unit indicates that the electronic device is not in the second operation mode, the acceptance unit accepts the setting change operation for the specific setting item, and the first acquisition unit does not acquire the first information.

7. The information processing apparatus according to claim 5,
wherein, in a case where the second information acquired by the second acquisition unit indicates that the electronic device is in the second operation mode, the acceptance unit does not accept the setting change operation for the specific setting item, and the first acquisition unit acquires the first information.

8. The information processing apparatus according to claim 1,
wherein, in response to transmission of the content of the setting change to the electronic device, the first acquisition unit acquires the first information based on receiving a response indicating that the content of the setting change cannot be accepted.

9. The information processing apparatus according to claim 1,
wherein information to be transmitted is encrypted in transmission of the content of the setting change, which is accepted via the screen based on the first information for displaying the setting change screen, to the electronic device.

10. The information processing apparatus according to claim 1,
wherein the screen based on the first information for displaying the setting change screen is a screen displayed by a web browser.

11. The information processing apparatus according to claim 1,
wherein the first information for displaying the setting change screen is information for accessing a web server in the electronic device.

12. An electronic device capable of communicating with an information processing apparatus, the electronic device comprising at least one memory and at least one processor and/or at least one circuit which function as:
a switching unit configured to switch to either one of a plurality of modes including a first operation mode and a second operation mode, the first operation mode allowing a setting change of a specific setting item related to the electronic device without performing predetermined user authentication, and the second operation mode not allowing the setting change of the specific setting item unless the predetermined user authentication is performed; and
a transmission unit configured to transmit, to the information processing apparatus, first information for displaying a setting change screen that is displayable after the predetermined user authentication is performed in a case of the second operation mode.

13. An information processing system including an information processing apparatus and an electronic device,
the information processing apparatus comprising at least one memory and at least one processor and/or at least one circuit which function as:
an acceptance unit configured to accept a setting change operation for a specific setting item of the electronic device;
a first transmission unit configured to transmit, to the electronic device, a content of a setting change accepted by the acceptance unit, in order to reflect the content of the setting change in the electronic device;
a first acquisition unit configured to acquire, from the electronic device, first information for displaying a setting change screen that is displayable after predetermined user authentication is performed in a case where the electronic device is in a second operation mode, among a first operation mode in which the setting change of the specific setting item related to the electronic device is allowed without performing the predetermined user authentication and the second operation mode in which the setting change of the specific setting item is not allowed unless the predetermined user authentication is performed; and
a display control unit configured to perform control to display a screen based on the first information acquired by the first acquisition unit, and
the electronic device comprising at least one memory and at least one processor and/or at least one circuit which function as:
a switching unit configured to switch to either one of a plurality of modes including the first operation mode and the second operation mode; and
a second transmission unit configured to transmit the first information to the information processing apparatus in a case where the electronic device is in the second operation mode.

14. A control method of an information processing apparatus capable of communicating with an electronic device, the control method comprising:
an acceptance step for accepting a setting change operation for a specific setting item of the electronic device;
a transmission step for transmitting, to the electronic device, a content of a setting change accepted in the acceptance step, in order to reflect the content of the setting change in the electronic device;
a first acquisition step for acquiring, from the electronic device, first information for displaying a setting change screen that is displayable after predetermined user authentication is performed in a case where the electronic device is in a second operation mode, among a first operation mode in which the setting change of the specific setting item related to the electronic device is allowed without performing the predetermined user authentication and the second operation mode in which the setting change of the specific setting item is not allowed unless the predetermined user authentication is performed; and
a display control step for performing control to display a screen based on the first information acquired in the first acquisition step.

15. A control method of an electronic device capable of communicating with an information processing apparatus, the control method comprising:
a switching step for switching to either one of a plurality of modes including a first operation mode and a second operation mode, the first operation mode allowing a setting change of a specific setting item related to the electronic device without performing predetermined user authentication, and the second operation mode not allowing the setting change of the specific setting item unless the predetermined user authentication is performed; and
a transmission step for transmitting, to the information processing apparatus, first information for displaying a setting change screen that is displayable after the predetermined user authentication is performed in a case of the second operation mode.

16. A control method of an information processing system including an information processing apparatus and an electronic device,
the information processing apparatus comprising:
an acceptance step for accepting a setting change operation for a specific setting item of the electronic device;
a first transmission step for transmitting, to the electronic device, a content of a setting change accepted in the acceptance step, in order to reflect the content of the setting change in the electronic device;
a first acquisition step for acquiring, from the electronic device, first information for displaying a setting change screen that is displayable after predetermined user authentication is performed in a case where the electronic device is in a second operation mode, among a first operation mode in which the setting change of the specific setting item related to the electronic device is allowed without performing the predetermined user authentication and the second operation mode in which the setting change of the specific setting item is not allowed unless the predetermined user authentication is performed; and
a display control step for performing control to display a screen based on the first information acquired in the first acquisition step, and
the electronic device comprising:
a switching step for switching to either one of a plurality of modes including the first operation mode and the second operation mode; and
a second transmission step for transmitting the first information to the information processing apparatus in a case of the second operation mode.

17. A non-transitory computer readable storage medium storing a program which functions in an information processing apparatus capable of communicating with an electronic device and causes the information processing apparatus to function as:
an acceptance unit configured to accept a setting change operation for a specific setting item of the electronic device;
a transmission unit configured to transmit, to the electronic device, a content of a setting change accepted by the acceptance unit, in order to reflect the content of the setting change in the electronic device;
a first acquisition unit configured to acquire, from the electronic device, first information for displaying a setting change screen that is displayable after predetermined user authentication is performed in a case where the electronic device is in a second operation mode, among a first operation mode in which the setting change of the specific setting item related to the electronic device is allowed without performing the predetermined user authentication and the second operation mode in which the setting change of the specific setting item is not allowed unless the predetermined user authentication is performed; and
a display control unit configured to perform control to display a screen based on the first information acquired by the first acquisition unit.
